(19) United States
(12) Patent Application Publication
(10) Pub. No.: US 2025/0228646 A1
(43) Pub. Date: Jul. 17, 2025

(54) DENTAL DEVICE

(71) Applicant: Kalie Lanette Migneault, Moose Jaw (CA)

(72) Inventor: Kalie Lanette Migneault, Moose Jaw (CA)

(21) Appl. No.: 18/410,300

(22) Filed: Jan. 11, 2024

(51) Int. Cl. A61C 7/08

(52) U.S. Cl. CPC A61C 7/08

(57) ABSTRACT

A dental retainer that is configured to maintain the teeth of a wearer in fluid communication with the saliva production of the wearer's mouth. The present invention includes a body that is manufactured from a biocompatible plastic and has a semicircular profile. The body includes a bottom, front wall and rear wall that are contiguously formed to create an interior volume. The interior volume of the body includes a plurality of tooth receptacles wherein the tooth receptacles are configured to mateably surround each of the wearer's teeth. A reservoir is present at the bottom of each tooth receptacle and is configured to receive and store saliva therein. Apertures are formed in the front wall and have a passage operably coupled thereto wherein the saliva production in a wearer's mouth traverses through the passage into the reservoir of each tooth receptacle.

### FIELD OF THE INVENTION

The present invention relates generally to oral hygiene devices, more specifically but not by way of limitation, a dental retainer that is configured to be mounted to the teeth of a user wherein the retainer of the present invention is fluidly coupled to the interior of the mouth of the user so as to facilitate transfer of saliva from the interior of the mouth to reservoirs adjacent each tooth pocket in the retainer in order to maintain saliva in contact with the teeth.

### BACKGROUND

Oral hygiene is a critical part to overall oral and dental health. Routines that include regular brushing and flossing not only help maintain gums and teeth in a healthy condition, these practices can also assist in maintaining health of the overall individual. In addition to oral hygiene, natural saliva production plays a key role in overall oral health. Saliva plays a crucial role in maintaining the health of your teeth, and a primary function of saliva is to maintain a coating on the teeth that provides numerous benefits. One benefit of saliva is that it keeps the mouth moist, which is essential for the comfort and health of your oral tissues, including teeth and gums. Another benefit of saliva production is that saliva forms a protective barrier around your teeth, which can help prevent decay and other dental problems. An additional benefit of saliva in a person's mouth is that the saliva contains minerals like calcium and phosphate that help reinforce the enamel, the outer layer of the teeth, through a process called remineralization.

A further benefit of saliva production is that saliva helps neutralize acid in the mouth. Saliva helps neutralize acids produced by bacteria in the mouth, which can erode tooth enamel if left unchecked. Yet another benefit of saliva production is that saliva production helps cleanse the mouth, washing away food particles and bacteria, thus reducing the risk of cavities and gum disease. Lastly, an additional benefit of saliva production in the human mouth is disease prevention: Saliva contains enzymes that aid in controlling the growth of bacteria, fungi, and viruses in the mouth which can prevent infections.

Accordingly, there is a need for a dental device that is configured to be in fluid communication with the interior of the mouth so as to facilitate saliva contact with the surfaces of the teeth in the mouth of the user.

### SUMMARY OF THE INVENTION

It is the object of the present invention to provide a dental retainer configured to be in fluid communication with the mouth of the wearer wherein the present invention includes a body having a semicircular profile.

Another object of the present invention is to provide a dental retainer configured to be secured adjacent the teeth of a wearer and maintain the teeth in fluid communication with the saliva production of the wearer's mouth wherein the body includes a plurality of adjacent tooth receptacles configured to mateably receive teeth therein.

A further object of the present invention is to provide a dental retainer configured to be in fluid communication with the mouth of the wearer wherein the tooth receptacles have reservoirs formed proximate the bottom thereof.

Yet a further object of the present invention is to provide a dental retainer configured to be secured adjacent the teeth of a wearer and maintain the teeth in fluid communication with the saliva production of the wearer's mouth wherein the front wall of the body has apertures formed therein adjacent each tooth receptacle.

Still another object of the present invention is to provide a dental retainer configured to be in fluid communication with the mouth of the wearer wherein the apertures are fluidly coupled with the reservoirs at the bottom of the tooth receptacles with passages.

An additional object of the present invention is to provide a dental retainer configured to be secured adjacent the teeth of a wearer and maintain the teeth in fluid communication with the saliva production of the wearer's mouth wherein the body is manufactured from a moldable material.

Yet a further object of the present invention is to provide a dental retainer configured to be in fluid communication with the mouth of the wearer wherein the present invention is configured to be operably coupled with the teeth of a wearer.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a detailed view of a tooth receptacle of the body of the present invention; and

FIG. 2 is side perspective view of the present invention in the mouth of a wearer.

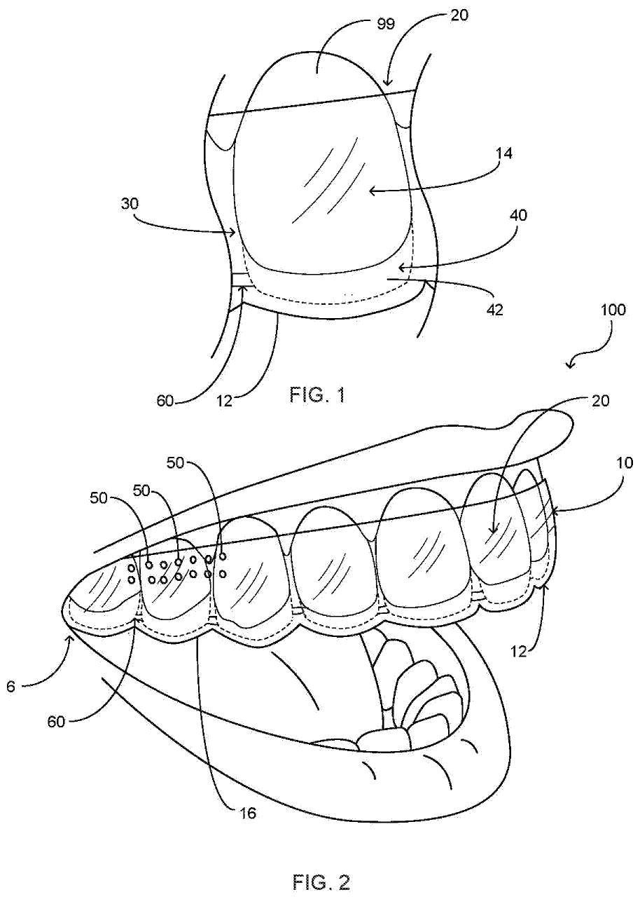

### DETAILED DESCRIPTION

Referring now to the drawings submitted herewith, wherein various elements depicted therein are not necessarily drawn to scale and wherein through the views and figures like elements are referenced with identical reference numerals, there is illustrated a dental retainer 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, e “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the dental retainer 100 includes a body 10 having a semicircular profile and is manufactured from a biocompatible plastic. The body 10 is configured to be releasably secured to the user's teeth as is illustrated herein in FIG. 2. The body 10 include a bottom 12, front wall 14 and rear wall 16 that are contiguously formed to create the shape of the body 10. The front wall 14 and rear wall 16 extend upward from the bottom 12 and are adjacent opposing sides of the wearer's teeth. The contiguous formation of the bottom 12, front wall 14 and rear wall 16 forms a cavity 20 wherein the cavity 20 has sufficient volume to accommodate a wearer's teeth therein.

The cavity 20 includes a plurality of tooth receptacles 30. The tooth receptacles 30 are molded to mateably fit each tooth of the wearer's teeth. It should be understood within a preferred embodiment of the scope of the present invention that the body 10 is manufactured from a mold of the wearer's teeth in order to ensure a proper fit. It is additionally contemplated within the scope of the present invention that the body 10 could be manufactured employing various suitable techniques. The tooth receptacles 30 surroundably mount each tooth 99 ensuing placement of the dental retainer 100. Proximate the bottom 12, each tooth receptacle 30 has a reservoir 40 formed therein. The reservoir 40 includes an interior volume 42 that is configured to receive and retain saliva therein.

The front wall 14 has formed therein apertures 50. Apertures 50 fluidly coupled to the reservoir 40. The apertures 50 function to facilitate the introduction of saliva production from the wearer's mouth into the reservoir 40. The reservoir 40 maintains the saliva therein and as such the wearer's teeth 99 are in constant fluid communication with the saliva production in the wearer's mouth. Apertures 50 are formed in the front wall 14 proximate the rear area 6 of the body 10 in order to facilitate collection of salvia from the parotid glands. For the dental retainer 100 that is configured to mateably couple with the bottom set of a wearer's teeth (not particularly illustrated herein), the apertures 50 are formed in the rear wall 16 so as to facilitate collection of saliva from the sublingual gland. While a plurality of apertures 50 are illustrated herein, it is contemplated within the scope of the present invention that the body 10 could employ as few as one aperture 50 in order to facilitate transfer of saliva production. A plurality of inter-receptacle passages 60 are further provided. It should be understood within the scope of the present invention that as few as one aperture 50 or a plurality of apertures 50 could be formed in the front wall 14 for the dental retainer 100 for the upper teeth and in the rear wall 16 for the dental retainer 100 configured to be placed on the bottom teeth of a wearer. The inter-receptacle passages 60 are hollow and facilitate fluid communication intermediate the tooth receptacles 30. While the preferred embodiment of the present invention includes inter-receptacle passages 60, it is contemplated within the scope of the present invention that the dental retainer 100 could be manufactured without the inter-receptacle passages. It should be further understood that during wearing of the dental retainer 100, if a user applies pressure typically in the form of biting down, the saliva stored in the reservoir 40 will traverse upwards and engage with the front and rear surfaces of the wearer's teeth.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A dental retainer that is configured to be mateably coupled to a wearer's teeth and maintain the teeth in fluid communication with saliva production wherein the dental retainer comprises:
a body, said body having a semicircular profile, said body having a bottom, a front wall and a rear wall, said bottom, said front wall and said rear wall being contiguously formed, said front wall and said rear wall extending upward from said body forming a cavity;
a plurality of tooth receptacles, said plurality of tooth receptacles being formed in said cavity, said plurality of tooth receptacles configured to mateably couple with each tooth of the wearer's teeth, said plurality of tooth receptacles each having a reservoir proximate a bottom thereof, said reservoir having an interior volume operable to receive and retain saliva therein, said plurality of tooth receptacles further having at least one aperture proximate thereto, said at least one aperture being placed in a first position and a second position of said body, said at least one aperture being fluidly coupled to said reservoir, said at least one aperture operable to facilitate transfer of saliva production into said reservoir.

2. The dental retainer configured to be mateably coupled to the wearer's teeth and maintain the teeth in fluid communication with saliva production as recited in claim 1, and further including a plurality of inter-receptacle passages, said inter-receptacle passages being hollow, said inter-receptacle passages being configured to fluidly couple adjacent tooth receptacles, said inter-receptacle passages operable to distribute saliva between adjacent tooth receptacles.

3. The dental retainer configured to be mateably coupled to the wearer's teeth and maintain the teeth in fluid communication with saliva production as recited in claim 2, wherein first position of said at least one aperture is in said front wall of said body.

4. The dental retainer configured to be mateably coupled to the wearer's teeth and maintain the teeth in fluid communication with saliva production as recited in claim 3, wherein second position of said at least one aperture is in said rear wall of said body.

5. The dental retainer configured to be mateably coupled to the wearer's teeth and maintain the teeth in fluid communication with saliva production as recited in claim 4, wherein said body is manufactured from a biocompatible plastic.
